(19) United States
(12) Patent Application Publication
(10) Pub. No.: US 2026/0228802 A1
(43) Pub. Date: Aug. 6, 2026

(54) SYSTEMS AND METHODS OF AUTOMATED RETAIL PRODUCT ASSORTMENT VIA ASSESSING QUALITATIVE AND QUANTITATIVE FEATURES OF RETAIL PRODUCTS

(71) Applicant: Walmart Apollo, LLC, Bentonville, AR (US)

(72) Inventors: Sahil Shirish Belsare, Cambridge, MA (US); Evan D. Fox, New York, NY (US); Xinyue Peng, Irvine, CA (US); Nikita Menon Kakkayur Palliyil, Jersey City, NJ (US)

(21) Appl. No.: 19/042,701

(22) Filed: Jan. 31, 2025

(51) Int. Cl. G06Q 30/0601; G06Q 10/0639

(52) U.S. Cl. CPC G06Q 30/0639; G06Q 10/06393

(57) ABSTRACT

In some embodiments, apparatuses and methods are provided herein useful to assess qualitative and quantitative features of items. In some embodiments, a system may include at least one database storing item data associated with at least one retail item of the plurality of retail items, and a trained machine learning model coupled to the at least one database, wherein the trained machine learning model, when executed by a processor-based control circuit of a computing device: obtains the item data from the at least one database, processes the item data obtained from the at least one database to generate a numerical value for two or more features of the at least one retail item; and consolidates each numerical value associated with the two or more features of the at least one retail item into an overall numerical value of the at least one retail item.

### TECHNICAL FIELD

This disclosure relates generally to assortment of items at a retail facility and, more particularly, to assortment of items at the retail facility for automated item replenishment and order fulfilment purposes.

### BACKGROUND

Many retail facilities include product storage areas (e.g., a micro fulfillment center (MFC)) designated for automated pickup and delivery (APD) purposes. Determining which retail items to store in an area for APD processes can have an impact on costs incurred during the APD processes. Currently, retail items with high sales velocities are often stored in an MFC for APD processes while retail items with comparatively lower sales velocities are stored on a sales floor of the retail facility. As a result, retail items with high sales velocities that may otherwise be sub-optimal for APD processes (e.g., retail items with a short shelf-life) may be stored in an area for APD process while retail items with comparatively lower sales velocities that may otherwise be optimal for APD processes (e.g., retail items with a high brand affinity) may be stored on a sales floor, which may result in additional labor costs during the APD processes. As such, a need exists for systems and methods that can assess qualitative and quantitative features of retail items and facilitate an efficient assortment of items at a retail facility for replenishment and order fulfillment purposes.

### BRIEF DESCRIPTION OF DRAWINGS

Disclosed herein are embodiments of systems, apparatuses and methods pertaining to assorting retail items at a retail facility by assessing qualitative and quantitative features of the retail items. This description includes drawings, wherein:

FIG. 1 is a block diagram of a retail item assortment system in accordance with some embodiments.

FIG. 2 is a block diagram of a retail item assortment system in accordance with some embodiments.

FIG. 3 is a block diagram of a retail item assortment system in accordance with some embodiments.

FIG. 4 is a block diagram of a retail item assortment system in accordance with some embodiments.

FIG. 5 is a block diagram of a retail item assortment system in accordance with some embodiments.

FIG. 6 is a block diagram of a retail item assortment system in accordance with some embodiments.

FIG. 7 is a block diagram of a retail item assortment system in accordance with some embodiments.

FIG. 8 is a block diagram of a computing device in accordance with some embodiments.

FIG. 9 is a block diagram of instructions executable by a computing device in accordance with some embodiments.

FIG. 10A is a block diagram of a method of item assortment in accordance with some embodiments.

FIG. 10B is a block diagram of a method of item assortment in accordance with some embodiments.

FIG. 10C is a block diagram of a method of item assortment in accordance with some embodiments.

FIG. 10D is a block diagram of a method of item assortment in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses, and methods are provided herein useful to facilitate assortment of a plurality of retail items at a retail facility by assessing qualitative and quantitative features of the retail items. In some embodiments, a system includes at least one database storing item data associated with at least one retail item of the plurality of retail items; and a trained machine learning model operatively coupled to the at least one database, wherein the trained machine learning model, when executed by a processor-based control circuit of a computing device: obtains the item data associated with the at least one retail item from the at least one database; processes the item data associated with the at least one retail item obtained from the at least one database to generate a numerical value for two or more features of the at least one retail item; and consolidates each numerical value associated with the two or more features of the at least one retail item into an overall numerical value of the at least one retail item; wherein the overall numerical value is an aggregate of respective numerical values generated by the trained machine learning model for the two or more features of the at least one retail item; wherein the two or more features include at least one of a qualitative feature or a quantitative feature; and wherein the at least one of the qualitative feature or the quantitative feature is associated with a respective numerical value.

In some embodiments, a method of assorting a plurality of retail items at a retail facility by assessing qualitative and quantitative features of the retail items includes: via a trained machine learning model: obtaining item data associated with at least one retail item from at least one database, wherein the at least one database stores the item data associated with the at least one retail item of the plurality of retail items; processing the item data associated with the at least one retail item obtained from the at least one database to generate a numerical value for two or more features of the at least one retail item; and consolidating each numerical value associated with the two or more features of the at least one retail item into an overall numerical value of the at least one retail item; wherein the overall numerical value is an aggregate of respective numerical values for the two or more features of the at least one retail item; wherein the two or more features include at least one of a qualitative feature or a quantitative feature; and wherein the at least one of the qualitative feature or the quantitative feature is associated with a respective numerical value.

In some embodiments, a non-transitory computer-readable medium programmed with computer-executable instructions for operating a computing device including a control circuit that includes a processor, and a memory accessible by the processor and bearing the instructions executable by the processor, wherein the instructions, when executed by the processor, implement a method of assorting a plurality of retail items at a retail facility by assessing qualitative and quantitative features of a plurality of retail items, the method including: obtaining item data associated with at least one retail item from at least one database, wherein the at least one database stores the item data associated with the at least one retail item of the plurality of retail items; processing the item data associated with the at least one retail item obtained from the at least one database to generate a numerical value for two or more features of the at least one retail item; and consolidating each numerical value associated with the two or more features of the at least one retail item into an overall numerical value of the at least one retail item; wherein the overall numerical value is an aggregate of respective numerical values for the two or more features of the at least one retail item; wherein the two or more features includes at least one of a qualitative feature or a quantitative feature; and wherein the at least one of the qualitative feature or the quantitative feature is associated with a respective numerical value.

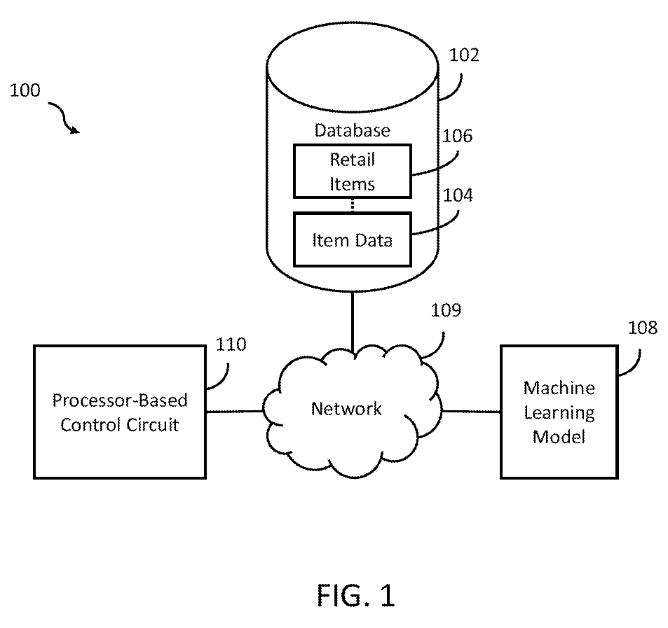

FIG. 1 illustrates a retail item assortment system 100 in accordance with some embodiments. In some aspects, the retail item assortment system 100 includes a database 102, a machine learning model 108, and a processor-based control circuit 110 communicatively coupled to each other over at least one network 109. The database 102 generally stores item data 104 associated with retail items 106. Example retail items 106 (which may also be referred to herein simply as “items”) may include, but are not limited to, any general-purpose consumer goods, as well as consumable and perishable products (e.g., food, grocery, beverage, items, etc.), medications, and dietary supplements.

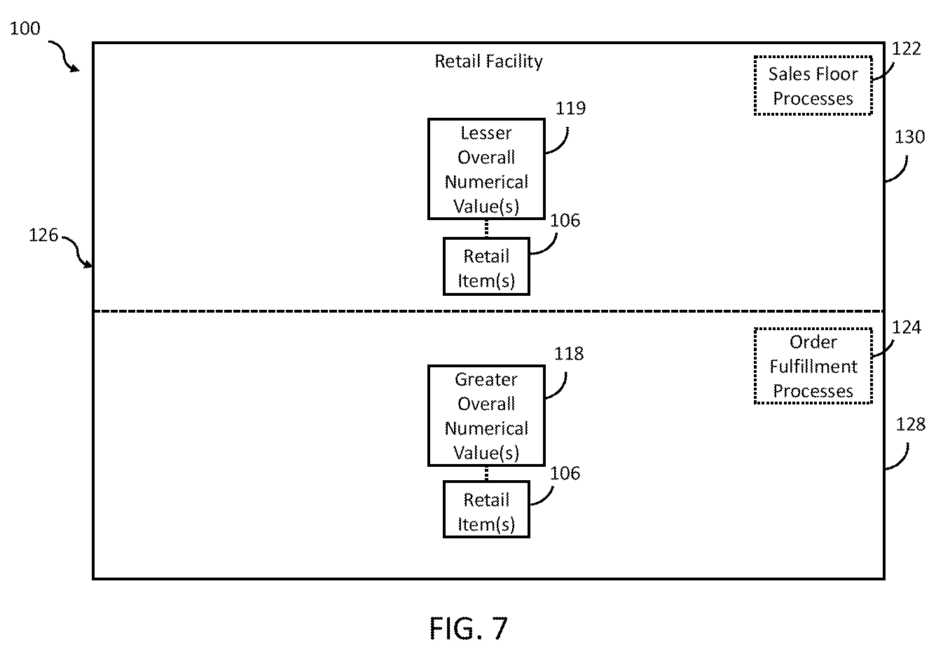

In some embodiments, the retail item assortment system 100 may further include any suitable user device configured to receive input (e.g., retail item to be assessed, locations available to store a retail item, processes the retail item may be used for, etc.) associated with the retail item assortment system 100. The retail item assortment system 100 is used to assess features of retail items and may be further used for purposes of assortment to determine where to allocate the retail items within a retail facility. In some aspects, the retail item assortment system 100 is used within a retail facility (such as the retail facility 126 shown in FIG. 7) and the retail items 106 are retail items stocked and/or offered for sale within the retail facility. As used herein, the term “retail facility” may refer to any place of business such as a store, warehouse, sorting facility, and/or distribution facility where consumer products may be stocked, and/or sold, and/or shipped to, and/or shipped from. In one example embodiment, the retail item assortment system 100 may be used to determine what retail items should be placed into a micro-fulfillment center (MFC) within a retail facility 126 to be used as a part of automated pickup and delivery (APD) processes.

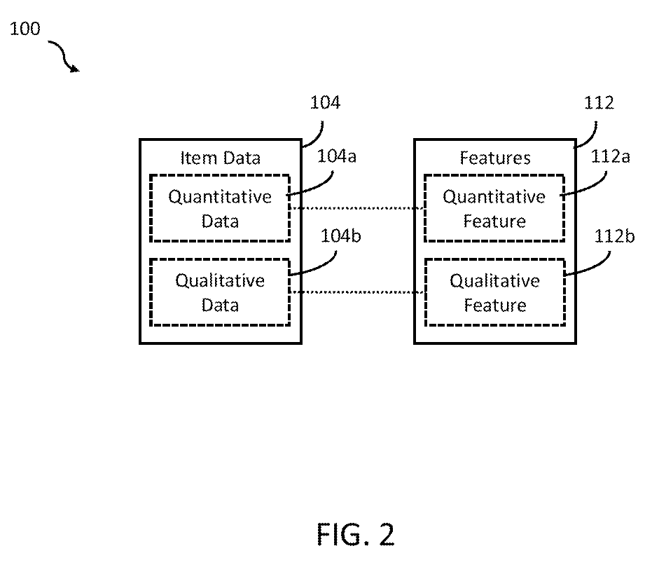

In some embodiments, the database(s) 102 are any suitable databases (e.g., hierarchical databases, relational databases, non-relational databases, object-oriented databases, and so forth) for storing item data 104 relevant to the retail item assortment system 100. With reference to FIG. 2, in some embodiments, the item data 104 includes quantitative data 104a (e.g., expiration costs, labor costs, historical order information (e.g., number of SKUs of a product ordered, types of order fulfillment relative to a specific product (e.g., in store orders vs online orders), and so forth, and item information (e.g., product name, sales, pre-substitution rate, shelf life, short-term margin, etc.)) and qualitative data 104b (e.g., customer lifetime value, brand affinity, etc.). Generally, quantitative data 104a is data directly associated with a numerical value (e.g., dollar value) and qualitative data 104b requires abstraction in order to be associated with a numerical value. In some embodiments, however, the quantitative data 104a and the qualitative data 104b are associated with features 112 such as a quantitative feature 112a and qualitative feature 112b respectively, and the quantitative data 104a and qualitative data 104b may include any data relevant to the respective feature 112.

In some embodiments, the network(s) 109 may be any suitable network or communication method such as, for example, a local area network (LAN), the Internet, wide area network (WAN), etc., communication link, other networks or communication channels with other devices and/or other such communications (not shown) or combination of two or more of such communication methods. In some aspects, there may be any combination of wired connections and/or wireless connections (e.g., Wi-Fi, Bluetooth, cellular, RF, and/or other such wireless communication) between the elements of the retail item assortment system 100.

In some embodiments, the machine learning model 108 of FIG. 1 may be any suitable trained machine learning model including decision trees, random forest, neural networks, deep learning, and so forth. In one example, the machine learning model 108 includes at least one of a random forest model, a regression model, and a simulation model. In the illustrated embodiment, the machine learning model 108 is operatively coupled with the processor-based control circuit 110 via the network 109, and the processor-based control circuit 110 may execute the machine learning model 108. In some embodiments, instructions stored in memory (e.g., of the processor-based control circuit 110 and/or external memory) may cause the processor-based control circuit 110 to output information and/or data from, for example, user device(s) and/or the database(s) 102 to be used by the machine learning model 108. The machine learning model 108 is generally pre-trained with data, and in some embodiments may be re-trained by any combination of manually input re-training data and/or self-learning methods.

In some embodiments, the processor-based control circuit 110 may include any suitable processing resource configured to execute instructions stored in a computer-readable storage memory (e.g., a non-transitory, computer-readable storage medium). In this context, the terms control circuit and controller refer broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The processor-based control circuit 110 or controller may be configured (for example, by using corresponding programming stored in a memory as will be well understood by those skilled in the art) to carry out one or more of the steps, actions, and/or functions described herein.

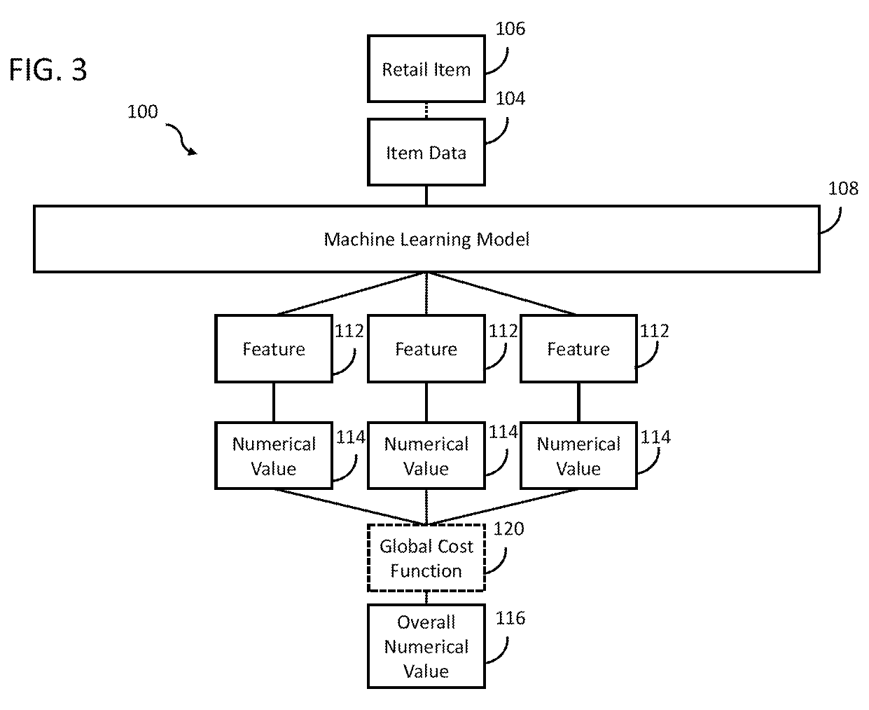

With reference to FIGS. 1 and 3., in some embodiments, the machine learning model 108 is pre-trained and operatively coupled to the at least one database 102, and the machine learning model 108, when executed by the processor-based control circuit 110 of a computing device, obtains the item data 104 associated with at least one retail item 106 of the retail items 106 from the at least one database 102. In some aspects, the machine learning model 108 processes the item data 104 associated with the at least one retail item 106 obtained from the at least one database 102 to generate a numerical value 114 for two or more features 112 of the at least one retail item 106. The machine learning model 108 further consolidates each numerical value 114 generated for two or more features 112 of the at least one retail item 106 into an overall numerical value 116 of the at least one retail item 106.

In some embodiments, the features 112 are categories related to a retail item 106 which can be used to assess the retail item 106. Generally, the features 112 include quantitative features 112a (i.e., directly associated with a numerical value 114) and qualitative features 112b (i.e., which require abstraction to be associated with a numerical value 114). In some embodiments, as shown in FIG. 2, the quantitative data 104a is associated with a quantitative feature 112a, and the qualitative data 104b is associated with a qualitative feature 112b.

A quantitative feature 112a is generally a feature 112 directly associated with a numerical value 114, such as, for example, sales velocity and/or pick productivity. Sales velocity is generally a measurement of how long it takes for a retail item 106 to be purchased after becoming available for sale at a retail facility. Pick productivity is generally productivity gains from storing a retail item 106 for APD processes versus storing a retail item 106 on a sales floor of the retail facility and can be determined from, for example, units per labor hour (UPLH) in an MFC including MFC pick labor costs and UPLH in a facility including sales floor pick labor costs.

A qualitative feature 112b is generally a feature 112 abstracted by the machine learning model 108 that is not directly associated with a numerical value 114 pre-abstraction such as, for example, customer experience and/or inventory control and quality assurance. Customer experience is generally a customer’s perception of a facility after a shopping and/or ordering experience and may be abstracted from pre-substitution rates including short-term gross merchandise volume (GMV), long-term GMV, nil pick time (i.e., the time taken by an associate to look for a retail item before determining the retail item is not in stock at the retail facility), substitution pick time (i.e., the time taken by an associate to pick a substitute retail item when the original retail item is not in stock), and/or exception time (i.e., the time taken by an associate to pick a retail item from a different area of the retail facility than initially intended such as a sales floor instead of an MFC).

Inventory control and quality assurance (ICQA) is a feature 112 generally related to wastage and expiration and can be abstracted from expired units on a SKU level including shrink cost (expiration). It is generally contemplated that the retail item assortment system 100 may evaluate any additional or alternative features 112 relative to the features 112 described above.

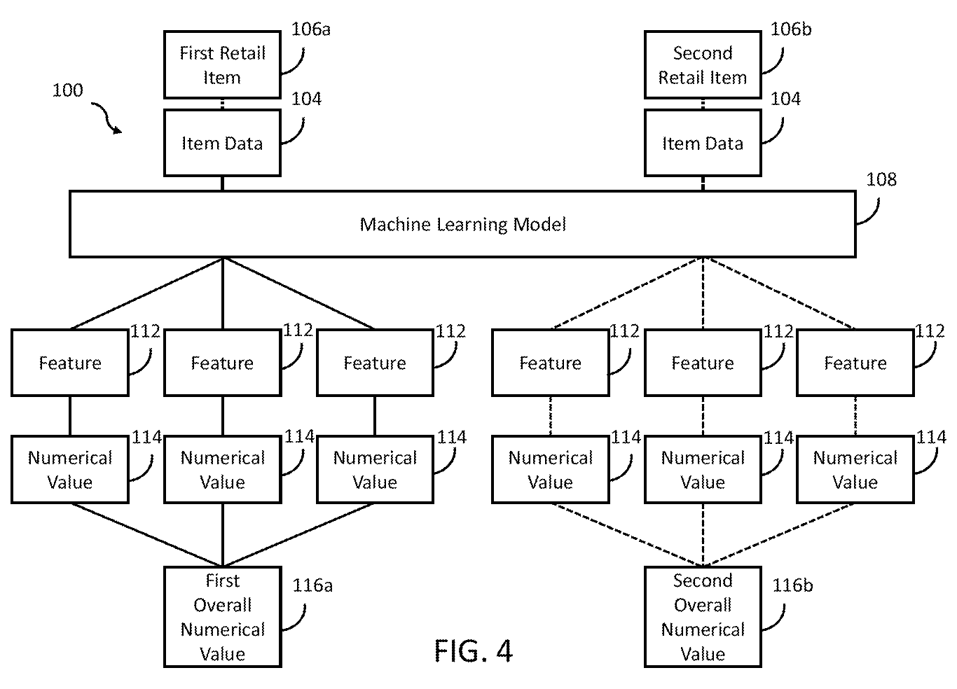

In some embodiments, the numerical values 114 are quantitative representations which allow the retail items 106 to be weighted in a standardized manner. In some embodiments, the numerical values 114 are dollar values, but it is generally contemplated that any alternate quantifiable value may be used instead of a dollar value. Generally, each feature 112 is associated with a respective numerical value 114 and each numerical value 114 associated with a specific retail item 106 is aggregated into the overall numerical value 116. In some embodiments, the overall numerical value 116 is an aggregate of respective numerical values 114 generated by the trained machine learning model for each of the features 112 of a retail item 106. In the embodiments shown in FIGS. 3 and 4, the machine learning model 108 generates the numerical values 114, but it is generally contemplated that, in some aspects, the numerical values 114 are generated from instructions/code executed by the processor-based control circuit 110 and/or are directly taken from the item data 104.

In some embodiments, the retail item assortment system 100 may generate a numerical value 114 for any number of features 112 and is scalable such that features 112 can be added and/or removed from the retail item assortment system 100. For example, the machine learning model 108 may generate a first numerical value 114 for a first feature 112 of a retail item 106 and generate a second numerical value 114 for a second feature 112 of the retail item 106. Further, the first numerical value 114 and the second numerical value 114 may be consolidated into the overall numerical value 116.

In the embodiment shown in FIG. 3, the machine learning model 108 obtains a global cost function 120 associated with the retail item 106 from the database 102 and consolidates the obtained global cost function 120 with each numerical value 114 for each feature 112 of the retail item 106 into the overall numerical value 116 of the retail item 106. The global cost function 120 is generally a function which maps values (e.g., the numerical values 114) of one or more variables (e.g., the features 112) onto a real number (e.g., the overall numerical value 116) representing a final value associated with, for example, a retail item 106.

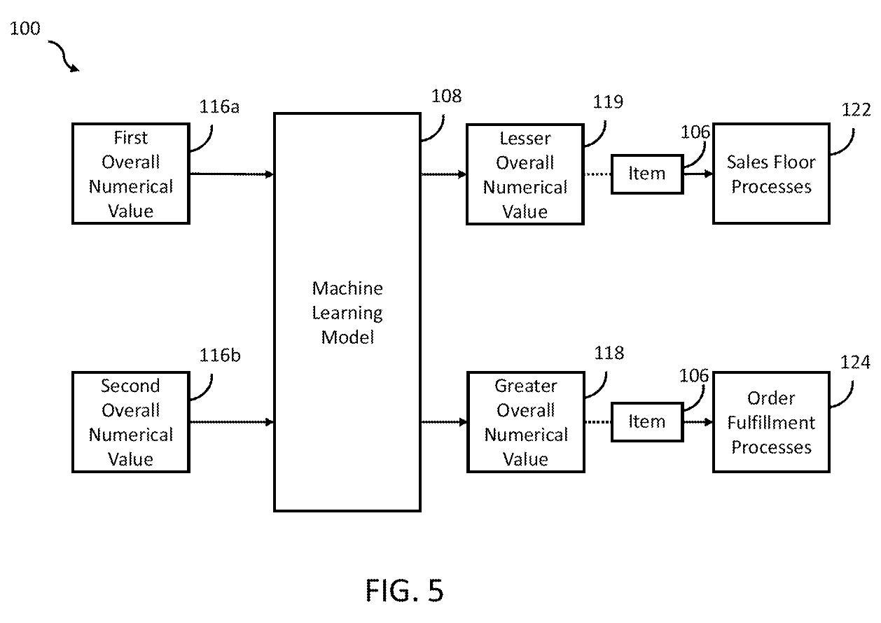

In some embodiments, the retail item assortment system 100 determines a numerical value 114 for each of the features 112 for each retail item 106 assessed by the retail item assortment system 100. For example, in the embodiments shown in FIGS. 4 and 5, the machine learning model 108 generates a first overall numerical value 116a for a first retail item 106a and generates a second overall numerical value 116b for a second retail item 106b. While FIG. 4 shows the first and second overall numerical values 116a, 116b being generated by the machine learning model 108 for two retail items 106, it is generally contemplated that any number of overall numerical values 116 for any number retail items 106 may be generated by the machine learning model 108.

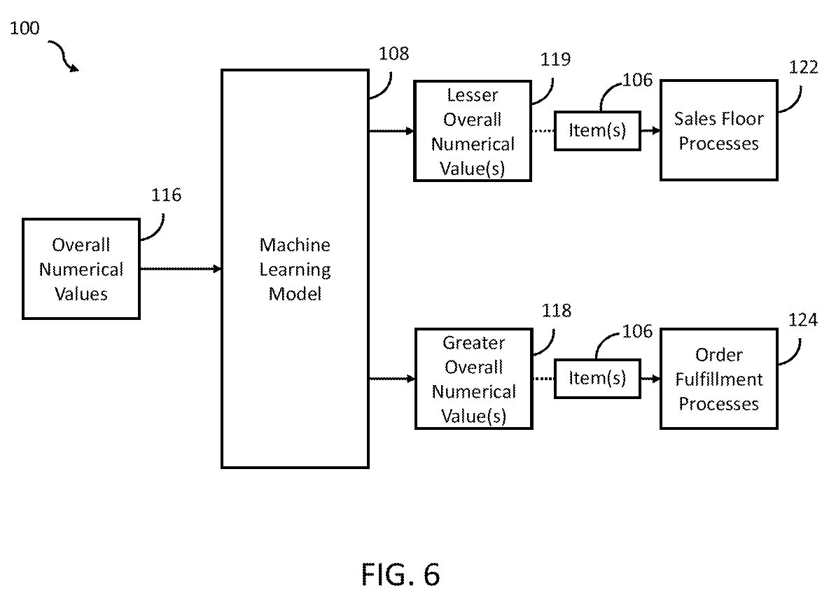

Further referring to FIGS. 5 and 6, in some aspects, the machine learning model 108 compares the first overall numerical value 116a and the second overall numerical value 116b to determine which is greater, and, in response to a determination by the machine learning model 108 as to which of the first overall numerical value 116a and the second overall numerical value 116b is greater, the machine learning model 108 allocates which of the first retail item 106a and the second retail item 106b is to be stored in an area for order fulfillment processes 124 and which of the first retail item 106a and the second retail item 106b to be stored in an area for sales floor processes 122. In some embodiments, the machine learning model 108 allocates a retail item 106 with a greater overall numerical value 118 for the order fulfillment processes 124 and allocates a retail item 106 with a comparatively lesser overall numerical value 119 for sales floor processes 122.

In some embodiments, the machine learning model 108 selects a subset of the retail items 106 based on a respective overall numerical value 116 for each retail item 106 of multiple retail items 106. Generally, the subset of the retail items 106 is selected such that the overall numerical values 116 of the retail items 106 in the subset are greater than the overall numerical values 116 of retail items 106 not in the subset. The subset of the retail items 106 may include any number of the retail items 106. In one example, the number of the retail items 106 in the subset is less than the number of the retail items 106 not in the subset, though it is generally contemplated that the number of retail items 106 in each subset of the multiple retail items 106 may vary from subset to subset in any suitable manner (e.g., equal subsets and/or subsets with comparatively different numbers of retail items 106).

In some embodiments, as shown in FIG. 7, the retail items 106 in the subset are stored in a first area 128 (e.g., the MFC and/or an order fulfillment area) of the retail facility 126 and the retail items 106 not in the subset are stored in a second area 130 (e.g., the sales floor) of the retail facility 126. In further embodiments, the machine learning model 108 designates the retail items 106 in the subset to be used for order fulfillment processes 124 based on the overall numerical values 116 of the retail items 106 in the subset being greater than the overall numerical values of the retail items 106 not in the subset. The machine learning model 108 may further designate the retail items 106 not in the subset to be used for sales floor processes 122 based on the overall numerical values 116 of the retail items 106 not in the subset being less than the overall numerical values 116 of the retail items 106 in the subset.

In other words, retail items 106 with comparatively lesser overall numerical value 119 are used for sales floor processes 122 and stored in a second area 130 of the retail facility 126 and retail items 106 with greater overall numerical value 118 are used order fulfillment processes 124 and stored in a first area 128 of the retail facility 126. While two areas 128, 130 of the retail facility 126 are described herein, it is generally contemplated that any number of areas 128, 130 of the retail facility 126 may be used and any number of respective subsets of retail items 106 may be allocated accordingly to each of the areas 128, 130 of the retail facility 126. In some embodiments, for example, a retail item 106 having a greater overall numerical value 118 that is designated to be stored in a MFC of a retail facility 126, may be a retail item 106 that generally has a high brand affinity (e.g., cosmetic products and/or personal products such as makeup and shampoo). In another example, a retail item 106 having a comparatively lesser overall numerical value 119 that is designated to be stored on a sales floor of a retail facility 126 may be a retail item 106 that generally has a short shelf life (e.g., perishable items such as fruits and vegetables).

In one example, a retail item 106 assessed by the retail item assortment system 100 for assortment may be fresh blueberries. Fresh blueberries may have, for example, sales of 610 units/month (i.e., sales velocity) and a shelf life of three days (i.e., a qualitative feature 112b). Another retail item 106 assessed by the retail item assortment system 100 may be baby formula. A specific type of baby formula may have, for example, sales of 12 units/month (i.e., sales velocity) and a pre-substitution rate of 60% (i.e., a qualitative feature 112b). Previous systems and methods for the assortment of retail items 106 may have delegated fresh blueberries to be stored in a first area 128 (e.g., an MFC) and the baby formula to be stored in a second area 130 (e.g., a sales floor) of the retail facility 126 because fresh blueberries have more sales per month than baby formula.

In contrast, the retail item assortment system 100 may determine that fresh blueberries have a contribution profit (CP) benefit of -$1.75/day (e.g., an overall numerical value 116) in comparison to previous systems and methods for assorting retail items 106. The retail item assortment system 100 may also determine that baby formula has a CP benefit of $2/day (e.g., an overall numerical value 116) in comparison to previous systems and methods for assorting retail items 106. In other words, the retail item assortment system 100 determines that it is less profitable to store fresh blueberries in an MFC because of the short shelf life, and more profitable to store baby formula in an MFC because of the high pre-substitution rate. The retail item assortment system 100 would delegate the fresh blueberries to be stored in the second area 130 of the retail facility 126 and the baby formula in the first area 128 of the retail facility 126 because the fresh blueberries have a comparatively lesser overall numerical value 119 than the baby formula which has a greater overall numerical value 118.

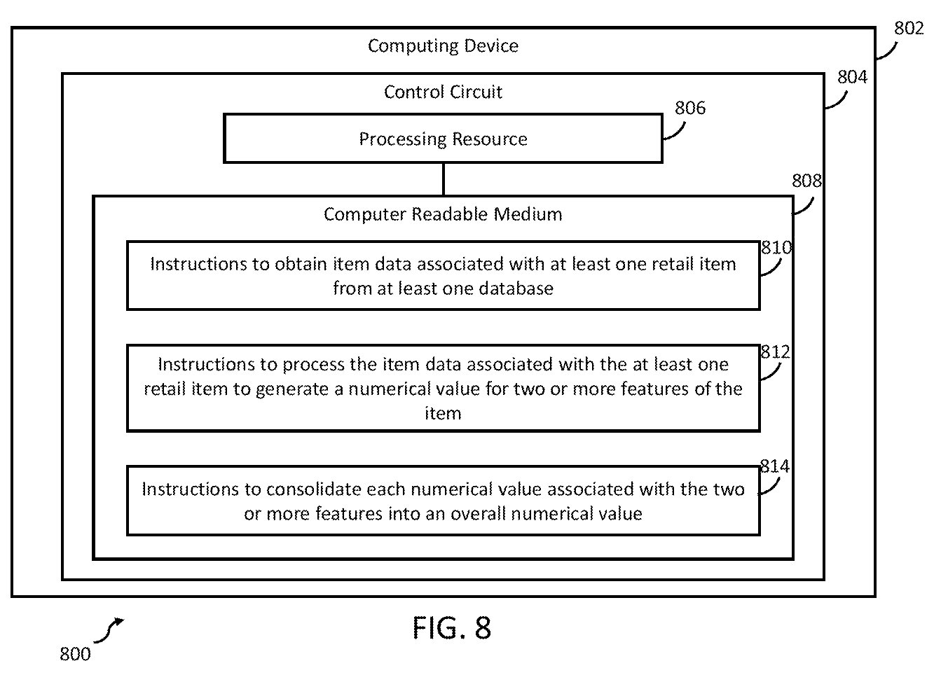

FIG. 8 shows an item assortment system 800 in accordance with some embodiments. The item assortment system 800 may, in some embodiments, be the retail item assortment system 100 and/or components thereof. The item assortment system 800 generally includes a non-transitory computer-readable medium 808 programmed with computer-executable instructions (e.g., instructions 810, 812, 814) for operating a computing device 802 including a control circuit 804 that includes a processor 806 and the non-transitory computer-readable medium 808 bearing the instructions 810, 812, 814 executable by the processor 806.

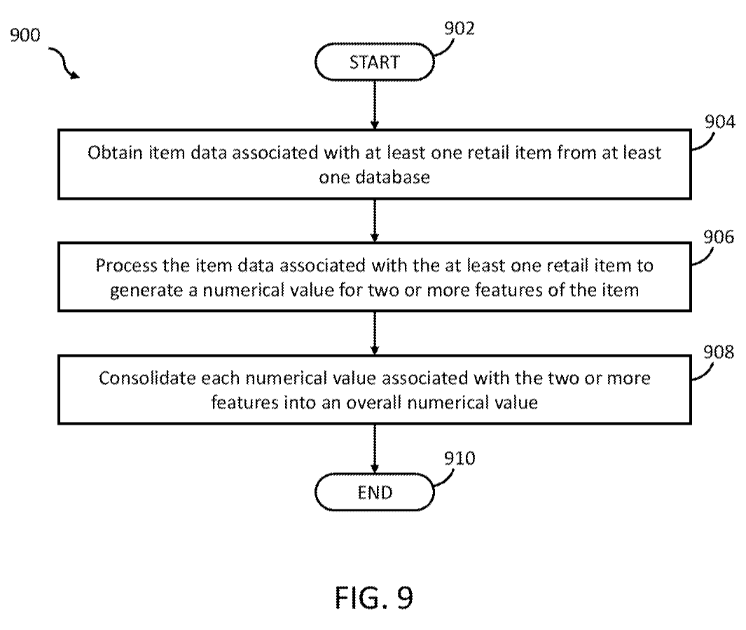

Further referring to FIG. 9, in some embodiments, the instructions 810, 812, 814, when executed by the processor 806, implement a method 900 of assorting a plurality of retail items at a retail facility by assessing qualitative and quantitative features of a plurality of retail items. The method 900 begins at a starting step 902, and the instructions 810, when executed by the processor 806, implement a step 904 of the method 900 of obtaining item data associated with at least one retail item from at least one database. Generally, the at least one database stores the item data associated with the at least one retail item of the plurality of retail items. The instructions 812, when executed by the processor 806, implement a step 906 of the method 900, which involves processing the item data associated with the at least one retail item obtained from the at least one database to generate a numerical value for two or more features of the at least one retail item. The instructions 814, when executed by the processor 806, implement a step 908 of the method 900, which involves consolidating each numerical value associated with the two or more features of the at least one retail item into an overall numerical value of the at least one retail item ending with an end step 910. Generally, the overall numerical value is an aggregate of respective numerical values for the two or more features of the at least one retail item. The two or more features includes at least one of a qualitative feature or a quantitative feature, and the at least one of the qualitative feature or the quantitative feature is associated with a respective numerical value.

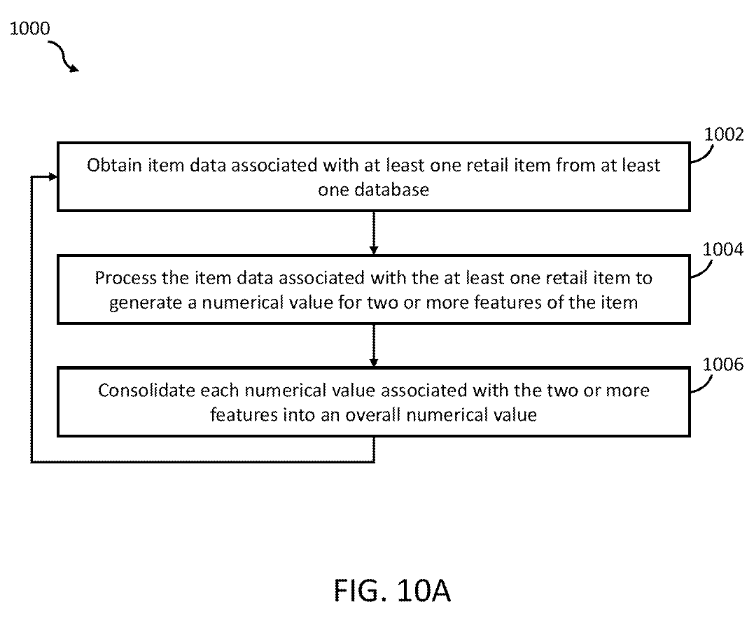

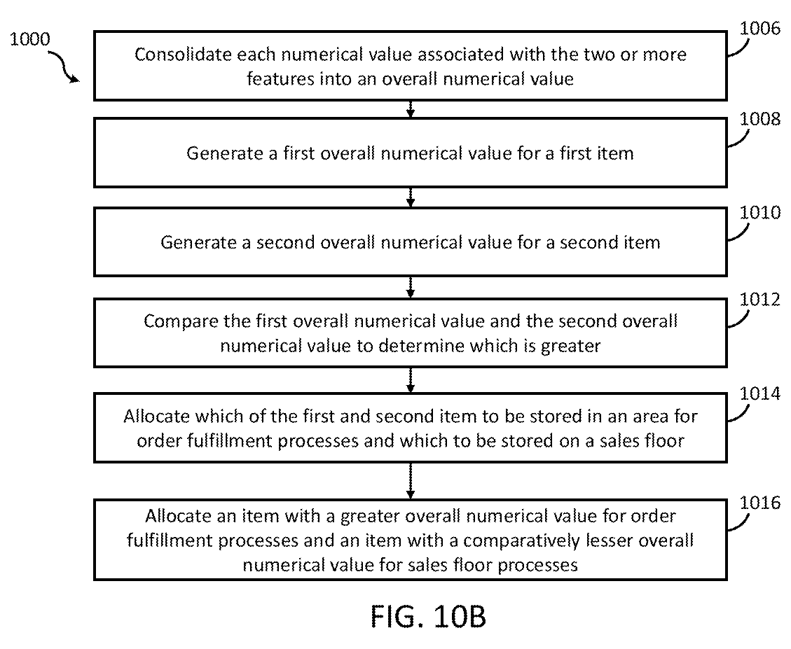

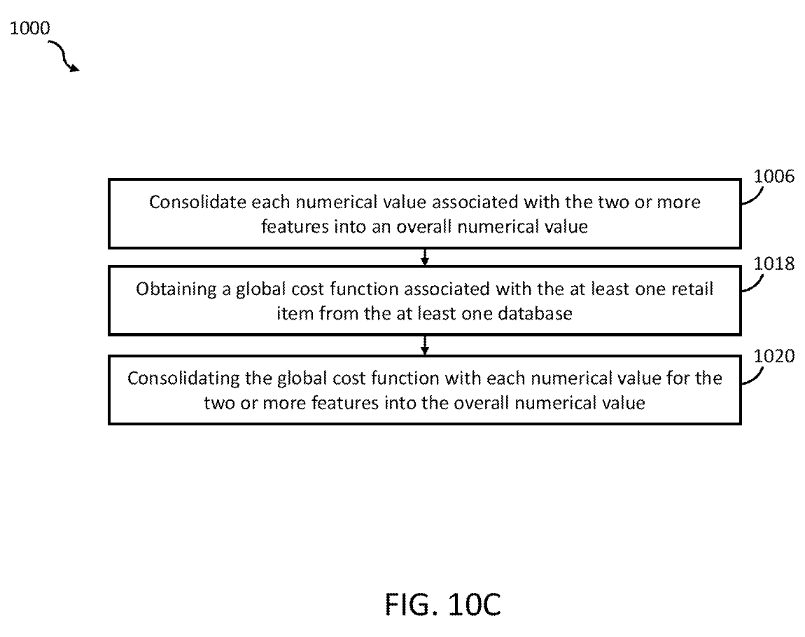

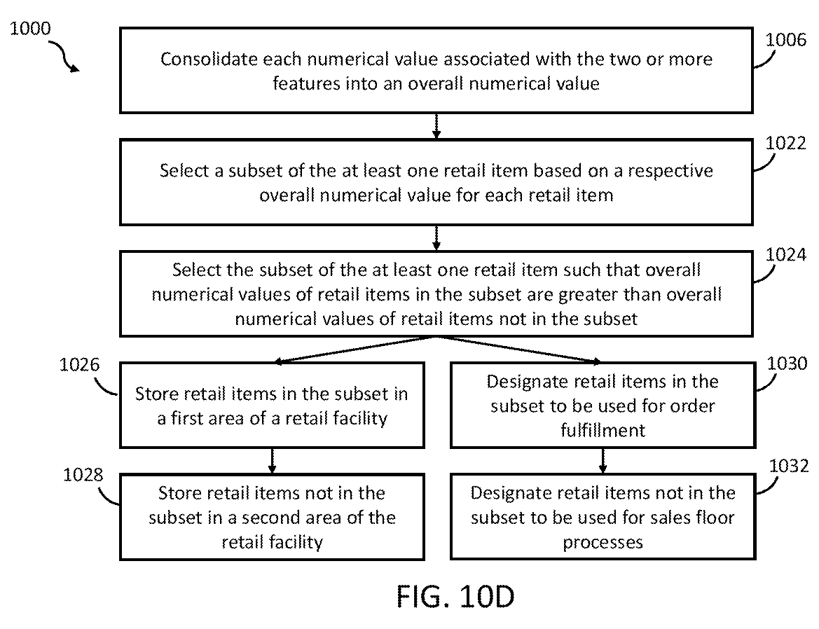

FIGS. 10A-10D show a method 1000 of assessing qualitative and quantitative features of a plurality of items in accordance with some embodiments. In some embodiments, the method 1000 may be implemented by the retail item assortment systems 100, 800 and or components of the retail item assortment systems 100, 800. In some embodiments, the method 1000 is the same as and/or similar to the method 900 described herein.

Referring to FIG. 10A, in some embodiments, the method 1000 includes a step 1002 of obtaining, via a trained machine learning model, item data associated with at least one retail item from at least one database. In some embodiments, the trained machine learning model is at least one of a random forest model, a regression model, and/or a simulation model. Generally, the at least one database stores the item data associated with the at least one retail item of the plurality of retail items. In some embodiments, the item data stored in the at least one database includes qualitive data representative of a qualitive feature associated with at least one retail item and quantitative data representative of a qualitative feature associated with the at least one retail item. In some aspects, the qualitative data includes at least one of customer lifetime value and brand affinity and the quantitative data includes at least one of expiration costs (i.e., costs incurred when an item expires), labor costs (i.e., costs incurred from employees of a facility performing processes of the facility), and historical order information (e.g., number of SKUs of a product ordered, types of order fulfillment relative to a specific product (e.g., in store orders vs online orders), and so forth).

The method 1000 illustrated in FIG. 10A further includes a step 1004 of processing, via the trained machine learning model, the item data associated with the at least one retail item obtained from the at least one database to generate a numerical value for two or more features of the at least one retail item. In some embodiments, the method 1000 includes a step of generating, via the trained machine learning model, a first numerical value for a first feature of the at least one retail item, and a step of generating, via the trained machine learning model, a second numerical value for a second feature of the at least one retail item. In some embodiments, the method 1000 includes generating, via the trained machine learning model, the numerical value for the qualitative feature of the at least one retail item and for the quantitative feature of the at least one retail item. It is generally contemplated that there may be any number of features with respective numerical values generated via the trained machine learning model. In some embodiments, one of the first feature or the second feature is a quantitative feature and the other one of the first feature or the second feature is a qualitative feature, and the quantitative feature includes at least one of sales velocity and pick productivity and the qualitative feature includes at least one of customer experience and inventory control and quality assurance.

The method 1000 illustrated in FIG. 10A further includes a step 1006 of consolidating, via the trained machine learning model, each numerical value associated with the two or more features of the at least one retail item into an overall numerical value of the at least one retail item. In some embodiments, the overall numerical value is an aggregate of respective numerical values for the two or more features of the at least one retail item. The two or more features may include at least one of a qualitative feature or a quantitative feature, and the at least one of the qualitative feature or the quantitative feature is associated with a respective numerical value. In some embodiments, the method 1000 includes a step of combining, via the trained machine learning model, the first numerical value and the second numerical value of the at least one retail item described above into the overall numerical value of the at least one retail item. It is generally contemplated that there may be any number of features and respective numerical values consolidated into the overall numerical value via the trained machine learning model. In some embodiments, for example, as shown in FIG. 10C, the consolidating step 1006 of the method 1000 of FIG. 10A further includes a step 1018 of obtaining a global cost function associated with the at least one retail item from the at least one database, and a step 1020 of consolidating the global cost function associated with the at least one retail item with each numerical value for the two or more futures of the at least one retail item into the overall numerical value of the at least one retail item.

As illustrated in FIG. 10B, the method 1000 in some embodiments further includes a step 1008 of generating a first overall numerical value for a first item and a step 1010 of generating a second overall numerical value for a second item. In some embodiments, the method 1000 further includes a step 1012 of comparing the first overall numerical value and the second overall numerical value to determine which is greater, and a step 1014 of allocating, in response to a determination of which of the first overall numerical value and the second overall numerical value is greater, which of the first item and the second item is to be stored in an area for order fulfillment processes and which of the first item and the second item is to be stored on a sales floor for sales floor processes. In the embodiment illustrated in FIG. 10B, the method 1000 further includes a step 1016 of allocating an item with a greater overall numerical value for the order fulfillment processes and allocating an item with a comparatively lesser overall numerical value for the sales floor processes.

As illustrated in FIG. 10D, in some embodiments, the method 1000 further includes a step 1022 of selecting a subset of the at least one retail item based on a respective overall numerical value for each retail item of the at least one retail item, and a step 1024 of selecting the subset of the at least one retail item such that the overall numerical values of items in the subset are greater than overall numerical values of retail items not in the subset. After step 1024, in some embodiments, the method 1000 further includes a step 1026 of storing the retail items in the subset in a first area of a retail facility and a step 1028 of storing the retail items not in the subset in a second area of the retail facility. In other embodiments, after step 1024, the method 1000 further includes a step 1030 of designating the retail items in the subset to be used for order fulfillment based on the overall numerical values of the retail items in the subset being greater than the overall numerical values of the retail items not in the subset, and a step 1032 of designating the retail items not in the subset to be used for sales floor processes based on the overall numerical values of the retail items not in the subset being less than the overall numerical values of the retail items in the subset. In other words, retail items are allocated for specific purposes (e.g., order fulfillment and sales floor processes) and/or are allocated to be stored in specific areas (e.g., a MFC and a sales floor) depending on the overall numerical value associated with a respective retail item.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A system for assorting a plurality of retail items at a retail facility by assessing qualitative and quantitative features of the retail items, the system comprising:
at least one database storing item data associated with at least one retail item of the plurality of retail items; and
a trained machine learning model operatively coupled to the at least one database, wherein the trained machine learning model, when executed by a processor-based control circuit of a computing device:
obtains the item data associated with the at least one retail item from the at least one database;
processes the item data associated with the at least one retail item obtained from the at least one database to generate a numerical value for two or more features of the at least one retail item; and
consolidates each numerical value associated with the two or more features of the at least one retail item into an overall numerical value of the at least one retail item;
wherein the overall numerical value is an aggregate of respective numerical values generated by the trained machine learning model for the two or more features of the at least one retail item;
wherein the two or more features include at least one of a qualitative feature or a quantitative feature; and
wherein the at least one of the qualitative feature or the quantitative feature is associated with a respective numerical value.

2. The system of claim 1, wherein the trained machine learning model:
generates a first numerical value for a first feature of the at least one retail item;
generates a second numerical value for a second feature of the at least one retail item; and
consolidates the first numerical value and the second numerical value for the at least one retail item into the overall numerical value of the at least one retail item.

3. The system of claim 2, wherein one of the first feature or the second feature is a quantitative feature and another one of the first feature or the second feature is a qualitative feature;
wherein the quantitative feature includes at least one of sales velocity and pick productivity; and
wherein the qualitative feature includes at least one of customer experience and inventory control and quality assurance.

4. The system of claim 1, wherein the trained machine learning model:
generates a first overall numerical value for a first item;
generates a second overall numerical value for a second item; and
compares the first overall numerical value and the second overall numerical value to determine which is greater;
wherein, in response to a determination by the trained machine learning model which of the first overall numerical value and the second overall numerical value is greater, the trained machine learning model allocates which of the first item and the second item is to be stored in an area for order fulfillment processes and which of the first item and the second item is to be stored on a sales floor for sales floor processes; and
wherein the trained machine learning model allocates an item with a greater overall numerical value for the order fulfillment processes and allocates an item with a comparatively lesser overall numerical value for the sales floor processes.

5. The system of claim 1, wherein the item data stored in the at least one database includes qualitative data representative of the qualitative feature associated with the at least one retail item and quantitative data representative of the qualitative feature associated with the at least one retail item; and
wherein the qualitative data includes at least one of customer lifetime value and brand affinity and the quantitative data includes at least one of expiration costs, labor costs, or historical order information.

6. The system of claim 1, wherein the trained machine learning model generates the numerical value for the qualitative feature of the at least one retail item and for the quantitative feature of the at least one retail item; and
wherein the trained machine learning model includes at least one of a random forest model, a regression model, and a simulation model.

7. The system of claim 1, wherein the trained machine learning model:
obtains a global cost function associated with the at least one retail item from the at least one database; and
consolidates the obtained global cost function associated with the at least one retail item with each numerical value for the two or more features of the at least one retail item into the overall numerical value of the at least one retail item.

8. The system of claim 1, wherein the trained machine learning model:
selects a subset of the at least one retail item based on a respective overall numerical value for each retail item of the at least one retail item;
wherein the subset of the at least one retail item is selected such that overall numerical values of retail items in the subset are greater than overall numerical values of retail items not in the subset.

9. The system of claim 8, wherein the retail items in the subset are stored in a first area of a retail facility, and the retail items not in the subset are stored in a second area of the retail facility.

10. The system of claim 8, wherein the trained machine learning model:
designates the retail items in the subset to be used for order fulfillment based on the overall numerical values of the retail items in the subset being greater than the overall numerical values of the retail items not in the subset; and
designates the retail items not in the subset to be used for sales floor processes based on the overall numerical values of the retail items not in the subset being less than the overall numerical values of the retail items in the subset.

11. A method of assorting a plurality of retail items at a retail facility by assessing qualitative and quantitative features of the retail items, the method comprising:
via a trained machine learning model:
obtaining item data associated with at least one retail item from at least one database, wherein the at least one database stores the item data associated with the at least one retail item of the plurality of retail items;
processing the item data associated with the at least one retail item obtained from the at least one database to generate a numerical value for two or more features of the at least one retail item; and
consolidating each numerical value associated with the two or more features of the at least one retail item into an overall numerical value of the at least one retail item;
wherein the overall numerical value is an aggregate of respective numerical values for the two or more features of the at least one retail item;
wherein the two or more features include at least one of a qualitative feature or a quantitative feature; and
wherein the at least one of the qualitative feature or the quantitative feature is associated with a respective numerical value.

12. The method of claim 11, further comprising, via the trained machine learning model:
generating a first numerical value for a first feature of the at least one retail item;
generating a second numerical value for a second feature of the at least one retail item; and
combining the first numerical value and the second numerical value of the at least one retail item into the overall numerical value of the at least one retail item.

13. The method of claim 12, wherein one of the first feature or the second feature is a quantitative feature and another one of the first feature or the second feature is a qualitative feature;
wherein the quantitative feature includes at least one of sales velocity and pick productivity; and
wherein the qualitative feature includes at least one of customer experience and inventory control and quality assurance.

14. The method of claim 11, further comprising, via the trained machine learning model:
generating a first overall numerical value for a first item;
generating a second overall numerical value for a second item;
comparing the first overall numerical value and the second overall numerical value to determine which is greater;
allocating, in response to a determination of which of the first overall numerical value and the second overall numerical value is greater, which of the first item and the second item is to be stored in an area for order fulfillment processes and which of the first item and the second item is to be stored on a sales floor for sales floor processes; and
allocating an item with a greater overall numerical value for the order fulfillment processes and allocating an item with a comparatively lesser overall numerical value for the sales floor processes.

15. The method of claim 11, wherein the item data stored in the at least one database includes qualitative data representative of the qualitative feature associated with the at least one retail item and quantitative data representative of the qualitative feature associated with the at least one retail item; and
wherein the qualitative data includes at least one of customer lifetime value and brand affinity and the quantitative data includes at least one of expiration costs, labor costs, and historical order information.

16. The method of claim 11, further comprising, via the trained machine learning model:
generating the numerical value for the qualitative feature of the at least one retail item and for the quantitative feature of the at least one retail item;
wherein the trained machine learning model includes at least one of a random forest model, a regression model, and a simulation model.

17. The method of claim 11, wherein the consolidating further comprises:
obtaining a global cost function associated with the at least one retail item from the at least one database; and
consolidating the global cost function associated with the at least one retail item with each numerical value for the two or more features of the at least one retail item into the overall numerical value of the at least one retail item.

18. The method of claim 11, further comprising, via the trained machine learning model:
selecting a subset of the at least one retail item based on a respective overall numerical value for each retail item of the at least one retail item;
selecting the subset of the at least one retail item such that overall numerical values of retail items in the subset are greater than overall numerical values of retail items not in the subset;
storing the retail items in the subset in a first area of a retail facility; and
storing the retail items not in the subset in a second area of the retail facility.

19. The method of claim 18,
selecting a subset of the at least one retail item based on a respective overall numerical value for each retail item of the at least one retail item;
selecting the subset of the at least one retail item such that overall numerical values of retail items in the subset are greater than overall numerical values of retail items not in the subset; and
further comprising, via the trained machine learning model:
designating the retail items in the subset to be used for order fulfillment based on the overall numerical values of the retail items in the subset being greater than the overall numerical values of the retail items not in the subset; and
designating the retail items not in the subset to be used for sales floor processes based on the overall numerical values of the retail items not in the subset being less than the overall numerical values of the retail items in the subset.

20. A non-transitory computer-readable medium programmed with a computer-executable instructions for operating a computing device including a control circuit that includes a processor, and a memory accessible by the processor and bearing the instructions executable by the processor, wherein the instructions, when executed by the processor, implement a method of assorting a plurality of retail items at a retail facility by assessing qualitative and quantitative features of a plurality of the retail items, the method comprising:
obtaining item data associated with at least one retail item from at least one database, wherein the at least one database stores the item data associated with the at least one retail item of the plurality of retail items;
processing the item data associated with the at least one retail item obtained from the at least one database to generate a numerical value for two or more features of the at least one retail item; and
consolidating each numerical value associated with the two or more features of the at least one retail item into an overall numerical value of the at least one retail item;
wherein the overall numerical value is an aggregate of respective numerical values for the two or more features of the at least one retail item;
wherein the two or more features includes at least one of a qualitative feature or a quantitative feature; and
wherein the at least one of the qualitative feature or the quantitative feature is associated with a respective numerical value.
